(19) United States
(12) Patent Application Publication
(10) Pub. No.: US 2026/0228850 A1
(43) Pub. Date: Aug. 6, 2026

(54) METHOD OF GENERATING A SECURED COLOUR IMAGE, AND METHOD OF DETECTING TAMPERING

(71) Applicant: SICPA HOLDING SA, Prilly (CH)

(72) Inventor: Eric DECOUX, Vevey (CH)

(21) Appl. No.: 19/155,093

(22) PCT Filed: Feb. 7, 2024
(86) PCT No.: PCT/EP2024/052956

§ 371 Date: Aug. 8, 2025

(30) Foreign Application Priority Data
Feb. 10, 2023 (EP) 23156060.8

(51) Int. Cl. G06T 1/00; G06T 3/40; G06T 11/10

(52) U.S. Cl. CPC G06T 1/0042; G06T 3/40; G06T 11/10; G06T 2201/005

(57) ABSTRACT

A method of generating a secured colour image includes generating an encodable image from a digital colour image; converting the digital colour image into a monochrome image with reduced resolution; and generating the secured colour image by embedding the monochrome image with the reduced resolution into the encodable image using an embedding algorithm; where the embedding algorithm allows encoding one pixel of the monochrome image into pixel pairs of the encodable image; and for each pixel pair, the embedding algorithm sets an intensity of a first pixel of the pixel pair as a sum of a mean intensity I of the pixel pair and an increment δ, and the embedding algorithm sets an intensity of a second pixel of the pixel pair as the mean intensity I of the pixel pair minus the same increment δ.

### TECHNICAL FIELD

The present invention relates to the technical field of protecting a colour image against tampering. In detail, the present invention relates to a method of generating a secured colour image, to a secured colour image, and to a method of detecting tampering of a secured colour image.

### BACKGROUND ART

As a way of falsifying a physical or digital identity document (such as a passport, ID card, driver's license, subscription card, certificate, or the like), fraudsters sometimes use a genuine identity document and sophisticated tools for altering or morphing the identity photograph so that it matches a similar looking individual. In case of a sufficient resemblance between the legitimate holder and the illegitimate holder, a visual or even automatic check of the photograph can be deceived. Further, the modified photograph can remain visually compatible with security elements of the identity document that echo the photograph, such as a hologram copy of the original photograph, a ghost image, an image with pierced holes, a translucent window including a copy of the original photograph, or the like.

In case of the above-described tampering attack, most common security features of the identity document, such as intaglio printing or micro-printing are also useless.

Accordingly, there is a need for protecting photographs on identity documents against modifications by fraudsters. In other words, it is desirable to ensure that a photograph (or any other type of image) is the original.

In order to ensure that a photograph of an identity document is the original, U.S. Pat. No. 11,055,589 B2 encodes a set of attributes of the original photograph in a visible two-dimensional barcode, which is then printed near or around the photograph. The attributes encoded in the barcode contain information characterizing biometric features derived from the original photograph. In order to check that a photograph of an identity document is indeed the original one, biometric features are extracted from the photograph using an image processing tool, and said biometric features are compared with the information encoded in the barcode. This solution requires a performant image processing tool capable of extracting and processing biometric features. Further, identity documents are often small and have limited space available for printing a barcode such as the one described in U.S. Pat. No. 11,055,589 B2.

It is therefore an object of the invention to provide an improved secured colour image.

### SUMMARY OF THE INVENTION

According to a first aspect, a method of generating a secured colour image is provided. The method comprises:
receiving or capturing a digital colour image;
generating an encodable image from the digital colour image;
converting the digital colour image into a monochrome image;
reducing a resolution of the monochrome image to obtain a reduced monochrome image; and
generating the secured colour image by embedding the reduced monochrome image into the encodable image using an embedding algorithm modifying at least one colour component of a colour model associated with the encodable image; wherein
the embedding algorithm allows encoding one pixel of the reduced monochrome image into at least part of a pixel block of the encodable image, the pixel block including multiple pixels which form pixel pairs; and
for each pixel pair, the embedding algorithm sets an intensity of a first pixel of the pixel pair in the at least one colour component as a sum of a mean intensity I of the pixel pair in the at least one colour component and an increment δ, and the embedding algorithm sets an intensity of a second pixel of the pixel pair in the at least one colour component as the mean intensity I of the pixel pair in the at least one colour component minus the same increment δ.

The general idea of the method of generating a secured colour image is to insert an encoded monochrome photo into an original colour image (preferably a photograph), without changing its appearance for a naked eye (i.e., the change in the image is not detectable by a human eye). As a result, any modification of the secured colour image can be detected as being not compatible with the embedded encoded image. Advantageously, a modification of the secured colour image by fraudsters can be prevented. Moreover, as the encoded information is embedded within the original colour image, no additional space is required for printing the encoded information, as would be the case if the encoded information was provided in a two-dimensional barcode or the like.

The word “image” as used here-in refers to any type of graphical representation such as a photograph, an illustration, a painting, a drawing, or the like. Such an image can represent a human (preferably in a portrait format), an animal and/or any specific and uniquely distinguishable object.

The secured colour image can be generated to be printed on a physical medium (for example on an identity document such as a passport, ID card, driver's license, subscription card, certificate or the like) or to be digitally stored (for example for digital authentication) in a smartphone or in a chip of a biometric passport.

The digital colour image upon which the creation of the secured colour image is based can be captured from a real object or person using a camera, or it can be scanned (captured) from a physical image, preferably using a flatbed scanner. Alternatively, the digital colour image can be an existing file which can be received and/or retrieved for processing purposes, for example from a database, from a cloud, or the like.

The expression “encodable image” herein in particular refers to an image that has a sufficiently small dynamic range to encode additional information therein, in particular by performing a desired level of intensity modulation. Examples for rendering the digital colour image encodable will be described in the following.

The step of converting the digital colour image into a monochrome image can include converting the digital colour image or the encodable image into a monochrome image (i.e., a monochrome digital image). The term “monochrome image” can designate an image composed of shades of only one color. The monochrome image may be a greyscale image.

Reducing the resolution of the monochrome image in particular allows obtaining a low-resolution monochrome digital image, also referred to as “reduced monochrome image” (by reducing the density of pixels of the image). Providing a low-resolution monochrome image is advantageous as it has a reduced size thereby facilitating the handling and encoding of said image. Preferably, the monochrome image with the reduced resolution has a size that is at least 16 times smaller, preferably at least 30 or 50 times smaller than the encodable image.

Accordingly, the secured colour image is generated such as to include the reduced monochrome image (preferably with the reduced resolution) within the encodable image. This process is called “embedding” herein. The embedding of the reduced monochrome image is in particular performed by modifying intensities of specific pixels of the digital colour image such that the modification encodes the reduced monochrome image.

Preferably, the embedding algorithm modifies the intensities of pixels of at least one specific colour component of a colour model associated with the encodable image. The colour model associated with the encodable image can be any standard colour model such as RGB (red-green-blue), CMYK (cyan-magenta-yellow-black), RYB (red-yellow-blue), or the like, each color thereof corresponding to one colour component as described herein.

A “pixel” as defined herein forms the smallest element of an image. Each pixel has an intensity value (sometimes referred to as “pixel value”) indicating a color thereof. Said pixel value can be encoded in a predefined number of bits. The reduced monochrome image and the encodable image can respectively be composed of multiple pixels, wherein the number of pixels of the encodable image is preferably larger (for example at least 16 times larger) than the number of pixels of the reduced monochrome image. As such, one pixel from the reduced monochrome image can be encoded into multiple pixels from the encodable image.

In detail, the one pixel from the reduced monochrome image is associated with the multiple pixels from the encodable image, in particular according to a correspondence pattern (predefined specific pattern described in the following). The multiple pixels from the encodable image which are associated with the single pixel from the reduced monochrome image can form a pixel block. Such a pixel block is formed of at least two pixel pairs (each including two pixels). Pixel pairs from one pixel block can be preferably located next to one another in the encodable image or alternatively separated from one another, for example with other pixel pairs (belonging to other pixel blocks, for example) therebetween.

Preferably, each pixel pair of the encodable image encodes one bit of the pixel value of the encoded pixel of the reduced monochrome image. This is done by adjusting an intensity value of each pixel of a pixel pair such that one of the two pixels of a pixel pair has an intensity that is higher than the other pixel of the same pair, said difference (in particular the sign of the difference) in intensity specifying the value of the bit encoded by the pixel pair. In other words, a sign of the difference between the intensities of the two pixels of one pixel pair indicates whether the pixel pair encodes a “0” or a “1”. To achieve this encoding, the embedding algorithm sets an intensity of a first pixel of the pixel pair as a sum of a mean (average) intensity I of the pixel pair and an increment δ, and the embedding algorithm sets an intensity of a second pixel of the pixel pair as the mean intensity I of the pixel pair minus the same increment δ. The small increment δ in particular has a value that is equal to or smaller than 10% of the dynamic range of the encodable image. The value of the increment δ is preferably picked such as to be large enough to enable a reliable detection of the modification of the pixel intensities of the encodable image by ±δ (preferably, δ≥3% of the dynamic range of the encodable image), but small enough that the modification of the pixel intensities of the encodable image by ±δ remains indetectable by the human eye (preferably δ≤10% of the dynamic range of the encodable image).

Overall, an average intensity of the pixel pair remains unchanged by the addition or subtraction of the increment δ. As a result, the modification of the intensity of the pixel pair is not or barely visible to a human observer.

The method of generating the secured colour image can be performed entirely autonomously, for example using a computer comprising a processor configured to perform all the steps of the method of generating the secured colour image of the first aspect or of any embodiment thereof as described in the following.

According to an embodiment, the colour model is an RGB (red-green-blue) color model having a red component, a green component and a blue component as its colour components, wherein the embedding algorithm modifies only the red component and the blue component of the encodable image.

Modifying only the red and blue components of the encodable image is in particular advantageous because this accounts for the colour sensitivity of the human visual system to the different colour components of the RGB colour model, thereby rendering the encoding of the reduced monochrome image into the encodable image even less visible to the human eye. In detail, the human visual system is most sensitive to green (59% sensitivity) and less sensitive to red (30% sensitivity) and blue (11% sensitivity), so that red and blue are more adapted to hide information.

According to a further embodiment, the embedding algorithm modifies the red component and the blue component of the encodable image such that for a selected pixel pair, the embedding algorithm sets:
an intensity IR1 of the red component of a first selected pixel of the selected pixel pair as IR1=IR+δR, wherein IR designates the mean intensity I of the selected pixel pair in the red component and δR designates the increment δ for the red component;
an intensity IR2 of the red component of a second selected pixel of the selected pixel pair as IR2=IR−δR;
an intensity IB1 of the blue component of the first selected pixel of the selected pixel pair as IB1=IB−δB, wherein IB designates the mean intensity I of the selected pixel pair in the blue component and δB designates the increment δ for the blue component; and
an intensity IB2 of the blue component of the second selected pixel of the selected pixel pair as IB2=IB+δB.

When only the red and the blue components of the encodable image are modified, the embedding algorithm preferably performs opposite modifications on pixels of a same pixel pair for the two colour components. In other words, if the embedding algorithm adds the increment δ to a pixel of the selected pixel pair in the red component, the embedding algorithm subtracts the increment δ from the same pixel of the selected pixel pair in the blue component. Performing such opposite operations in the different colour components allows rendering the encoded information from the reduced monochrome image even less visible.

Preferably, the selected pixel pair is one of the pixel pairs of the pixel block. The first selected pixel of the selected pixel pair can correspond to the previously described first pixel of a pixel pair or to the previously described second pixel of a pixel pair. Similarly, the second selected pixel of the selected pixel pair can correspond to the previously described second pixel of a pixel pair or to the previously described first pixel of a pixel pair.

According to a further embodiment, the pixel pairs, in particular including the selected pixel pair, are arranged in a predefined specific pattern in the pixel block.

The predefined specific pattern is in particular indicative of which pixel of the reduced monochrome image is encoded in which pixel pairs of the encodable image. Preferably, all pixels of the reduced monochrome image are encoded somewhere in the encodable image using the embedding algorithm. A location of the pixel pairs in the encodable image encoding a pixel of the reduced monochrome image in particular corresponds to a location of said encoded pixel in the reduced monochrome image (for example, the top-leftmost pixel in the reduced monochrome image can be encoded in the top-leftmost pixel block of the encodable image). The pixel pairs encoding the reduced monochrome image can be spread all over the encodable image. The predefined specific pattern can define a seemingly random and/or disordered correspondence between encoded pixels from the reduced monochrome image and encoding pixel pairs of the encodable image. The predefined specific pattern can in particular be used to encode the secured colour image and/or to later decode the secured colour image obtained when the reduced monochrome image is encoded in the encodable image.

The predefined specific pattern can be a correspondence table indicating which pixel of the reduced monochrome image is encoded in which pixel pairs of the encodable image. The predefined specific pattern may provide coordinates of the pixel of the reduced monochrome image and corresponding coordinates of the pixel pairs of the encodable image encoding said pixel of the reduced monochrome image. The predefined specific pattern may further indicate, for each correspondence information comprised therein, a color component in which the pixel of the reduced monochrome image is encoded. There may also be a separate predefined specific pattern for each color component of the encodable image that encodes pixels of the reduced monochrome image.

Alternatively, a predefined ordering of pixels and/or pixel blocks in the reduced monochrome image and/or encodable image (e.g. for upper-leftmost to lower rightmost) is applied in the embedding step. In this way, a predefined specific pattern is not required.

According to a further embodiment, a value of the increment δ depends upon the modified colour component, in particular wherein
an increment δB for the blue component is larger than an increment δR for the red component, in particular wherein δR<δB/2, more particularly wherein δR=δB/3.

Picking a different value for the increment δ for each modified colour component allows compensating for the different sensitivities of the human visual system to the different colour components. As indicated above, since the human visual system has a 30% sensitivity to red and a 11% sensitivity to blue, having the increment δB for the blue component being larger than an increment δR for the red component (in particular δR<δB/2, more particularly δR=δB/3) allows compensating for the different sensitivities of the human visual system to the different colour components. Consequently, the encoded reduced monochrome image is even less visible to the human eye than if δR and δB were equal to each other.

According to a further embodiment, the step of generating an encodable image from the digital colour image comprises:
calculating a dynamic range of the digital colour image;
determining whether the calculated dynamic range allows for variations of plus and minus the increment δ;
if the calculated dynamic range does not allow for variations of plus and minus the increment δ, reducing the dynamic range of the digital colour image to obtain the encodable image;
if the calculated dynamic range allow for variations of plus and minus the increment δ, setting the digital colour image as the encodable image.

The “dynamic range” in particular designates a maximal intensity range of an image and calculating the dynamic range may correspond to finding the maximum pixel intensity and the minimum pixel intensity of the image. For example, for theoretically possible intensities comprised between 0 and 100, the maximal dynamic range is 100. Determining whether the calculated dynamic range allows for variations of plus and minus the increment δ corresponds to verifying whether the calculated dynamic range is compatible with a desired level of intensity modulation (said modulation resulting from the encoding of the reduced monochrome image into the encodable image, i.e., the addition or subtraction of the increment δ).

Preferably, the increment δ has a value of 10% of the maximal dynamic range or less. In particular, the increment δ has a value between 3% and 7% of the maximal dynamic range. The value of the increment δ is preferably picked such as to be large enough to enable a reliable detection of the modification of the pixel intensities of the encodable image by ±δ, but small enough that the modification of the pixel intensities of the encodable image by ±δ remains indetectable by the human eye.

In case the calculated dynamic range is compatible with a desired level of intensity modulation (said modulation resulting from the encoding of the reduced monochrome image into the encodable image, i.e., the addition or subtraction of the increment δ), the dynamic range of the digital image is not reduced. For example, if the dynamic range is of 90, with an intensity varying from 5 to 95 (which are examples for minimum and maximum intensity values and can be replaced by any other suitable values), no reduction is necessary if the δ=5 margin can be used to modulate the intensities. Note that δ=5 is used as an example and that a different value can be selected for the increment δ, preferably in line with the conditions defined above.

If the calculated dynamic range is of 100 (no margin left for modulation) or if the corresponding margin available for intensity modulation is not sufficient (in particular when the image comprises intensities between 0 and 5 or between 95 and 100 in the above example), then a reduction step is necessary to allow a (later) modulation of the intensities of the pixel intensities.

Reducing the dynamic range of the digital colour image can be done by rescaling the intensities of the entire colour image so that they all lie within the “allowable” range (5 to 95 in the above example). For example, the digital color image is first rescaled in intensity: the initial dynamic range IDR is reduced by multiplying the pixel intensities by a certain reduction factor f (e.g. if IDR=96 and thus 2δ=4, then with reduction factor f=0.94, we arrive at a reduced dynamic range RDR=f IDR=90 of which margin is now δ=5), and second, the reduced pixel intensities are optionally shifted by a shifting factor which will allow modulating the pixel intensities by 5% while saving a good contrast. Such a shifting factor can be a fraction of δ, for example.

Alternatively, reducing the dynamic range can correspond to cutting off extreme intensities (for example cutting off all intensities below 5 and replacing them by 5, and cutting off all intensities above 95 and replacing them by 95). Alternatively, reducing the dynamic range can correspond to a shifting of all intensities upwards or downwards.

According to a further embodiment, the pixel block includes 16 pixels arranged in a 4×4 matrix. The pixel block can form a square matrix of 4×4 pixels.

According to a further embodiment, the embedding algorithm encodes the one pixel of the reduced monochrome image into at least part of the pixel block of the encodable image by:
associating a binary number of N bits to a colour intensity of the one pixel of the reduced monochrome image; and
embedding each of the N bits associated with the colour intensity into one of N pixel pairs of the pixel block of the encodable image.

The intensity of each pixel of the reduced monochrome image can be represented by the binary number of N bits, where N is an integer number and N≥1. Preferably, the intensity of one pixel of the monochrome image is encoded in N pixel pairs of the encodable image.

According to a further embodiment, the embedding algorithm additionally encodes
an error-correction code and/or an error-detection code calculated from an intensity of at least one pixel of the reduced monochrome image; and/or
descriptive information regarding an object or a person represented on the digital colour image;
   wherein the error-correction code, the error-detection code and/or the descriptive information is at least partly stored into at least another pixel pair of the pixel block and/or of the encodable image;
   wherein in particular the error-correction code includes a Reed-Solomon code and/or the error-detection code includes a cyclic redundancy check (CRC) code.

The error-correction code can be a code word or the like that is calculated from information from the reduced monochrome image and allows to not only detect an error in said information but also to correct part of said information when the error-correction code is decoded. When decoding the secured colour-image, decoding the error-correction code may allow to correct some pixel intensity values that were read wrongly, for example due to scanning aberrations, damage to the secured colour image or the like.

The error-detection code can be a code word or the like that is calculated from information from the reduced monochrome image and allows to detect an error in said information when the error-detection code is decoded. When decoding the secured colour-image, decoding the error-detection code may allow to detect some pixel intensity values that are read wrongly. However, the error-detection code may not allow correcting these identified errors.

The error-correction code and/or the error-detection code can be calculated based on a pixel intensity of one or multiple pixels of the reduced monochrome image, a number of pixels of the reduced monochrome image or the like. Preferably, the error-correction code and/or the error-detection code encodes multiple pixels from the reduced monochrome image. The error-correction code and/or the error-detection code can form a binary representation of multiple pixels (for example a pixel block) from the reduced monochrome image.

The descriptive information can include information such as a name, date of birth, identity document number or the like of a person portrayed on the encodable image.

The error-detection code and the error-correction code are jointly be referred to as “error code” herein. The error code and/or the descriptive information can be encoded in any pixel pair of the encodable image that does not already encode the reduced monochrome image. For example, the error code and/or the descriptive information are encoded in half of the pixel pairs of the encodable image while the other half of the pixel pairs is for encoding the reduced monochrome image. For example, in a pixel block of 4×4 pixels, there are eight pixel pairs, four of which are for encoding the reduced monochrome image and four of which are for encoding the error code and/or the descriptive information.

The encoding of the error code and/or the descriptive information can be performed similarly to the encoding of the reduced monochrome image. Namely, each pixel pair may encode one bit, each pixel of the pixel pair being modified by adding or subtracting an increment δ to each respective pixel of the pixel pair.

According to a second aspect, a secured colour image is provided. The secured colour image is obtained by the method of the first aspect or of any embodiment of the first aspect and has embedded a corresponding encoded reduced monochrome image.

The embodiments and aspect described in view of the method of the first aspect also apply to the secured colour image of the second aspect.

According to a third aspect, a method of detecting tampering of a secured colour image is provided, the method of detecting tampering comprising:
receiving or capturing a secured colour image to be tested for tampering, the secured colour image having embedded a corresponding encoded reduced monochrome image;
optionally converting the secured colour image into a sampled monochrome image;
accessing a predefined pattern defining locations of pixel pairs encoding the reduced monochrome image in the secured colour image, and accessing at least one colour component information indicating a color component in which an encoding has been performed in the secured colour image, the colour component belonging to a colour model associated with the secured colour image;
decoding the secured colour image using a decoding algorithm applied to each pixel pair of the secured colour image defined in the predefined specific pattern, wherein the decoding algorithm calculates, for each pixel pair of the at least one colour component, a difference between intensities of the two pixels of the pixel pair;
restoring the reduced monochrome image embedded in the secured colour image based on a sign of the calculated difference for each pixel pair;
determining whether the secured colour image has been tampered upon comparing the restored monochrome image embedded in the secured colour image with the sampled monochrome image and/or with the secured colour image, and accordingly evaluating whether the restored monochrome image embedded in the secured colour image is visually similar with the sampled monochrome image and/or with the secured colour image.

The embodiments and aspect described in view of the method of the first aspect also apply to the method of detecting tampering of the third aspect.

“Tampering” herein refers to the performing of unauthorized modifications (alterations) to the secured colour image. According to the tampering detection method of the third aspect, any modification (tampering) of the colour image can be detected as being not compatible with the embedded encoded image. Advantageously, a modification of the colour image by fraudsters can be prevented.

The method of detecting tampering can be performed entirely autonomously, for example using a computer or a detection device comprising a processor configured to perform all the steps of the method of detecting tampering of the second aspect. In case of the autonomous tampering detection, the step of converting the secured colour image into a sampled monochrome image is preferably non-optionally performed, and the determining whether the secured colour image has been tampered is preferably non-optionally performed by comparing the restored monochrome image embedded in the secured colour image with the sampled monochrome image (and accordingly evaluating whether the restored monochrome image embedded in the secured colour image is visually similar with the sampled monochrome image).

“Receiving a secured colour image” may refer to retrieving or obtaining the secured colour image from a storage space, for example from a chip, preferably in digital form. “Capturing the secured colour image” may refer to scanning or photographing the secured colour image to obtain a digital version thereof. The secured colour image is preferably an image that has been created in accordance with the method of the first aspect or any embodiment thereof and accordingly includes a monochrome version of the image encoded therein.

The optional step of converting the secured colour image into a sampled monochrome image can correspond to obtaining a (sample) monochrome image of the secured colour image to be tested. The sampled monochrome image is for optional later comparison with the reduced monochrome image encoded within the colour image, in particular to detect tampering on the secured colour image. Said optional step of converting the secured colour image into a sampled monochrome image can further be followed by or include a step of reducing a resolution of the sampled monochrome image (in particular along the same lines as in the image reduction described above). This facilitates the comparison of the sampled monochrome image (with the reduced resolution) with the restored monochrome image.

The predefined specific pattern is as defined above and in particular indicates which pixel pairs of the secured colour image encode which pixel(s) of the (encoded) reduced monochrome image encoded in the secured colour image. Further, the colour component information can indicate in which colour layers of the secured colour image the encoding of the encoded reduced monochrome image into the secured colour image has been performed. The accessed predefined specific pattern and the colour component information allow starting the decoding algorithm to decode the secured colour image to retrieve the reduced monochrome image encoded therein. “Accessing” the predefined specific pattern and the colour component information can mean reading said information out of a storage unit, receiving said information and/or retrieving said information.

The decoding algorithm calculates, for each pixel pair defined in the predefined specific pattern and for the colour component defined in the colour component information, an intensity of a first pixel of the pixel pair minus an intensity of the second pixel of the pixel pair. This will result in either a positive or a negative value of twice the increment δ (i.e., ±2δ). Preferably, the predefined specific pattern also defines, for each pixel pair defined therein, an “order” of the pixels used to encode the bit therein (for example, if the first pixel has a higher value, a 0 is encoded, if the second pixel has a higher value, a 1 is encoded, or the other way around). Consequently, from the sign of the difference between pixel intensities calculated for a pixel pair, the value (bit) encoded by said pixel pair can be determined.

By determining all bits encoded by all pixel pairs and assembling them in accordance with the specific pattern, the bits associated with each encoded pixel of the reduced monochrome image are obtained. In other words, the intensities of each pixel of the reduced monochrome image can be obtained. This allows reconstructing (restoring) the reduced monochrome image embedded (encoded) in the secured colour image.

A visual (human or automatic) comparison of the restored monochrome image (i.e., the image hidden within the secured colour image) with the sampled monochrome image (i.e., the monochrome image obtained directly from the secured colour image) or with the secured colour image allows determining whether a tampering attack was performed on the secured colour image or not. In case of the comparison between the restored monochrome image and the secured colour image (without the sampled monochrome image), a human can look for features (such as hair, beard, glasses or the like) that were added to the secured colour image or removed therefrom as compared to the restored monochrome image. In particular, when there are significant differences between the restored monochrome image and the sampled monochrome image or the secured colour image (for example, more than a predefined number of pixel intensities diverge between the restored monochrome image and the sampled monochrome image), tampering is determined. If there are no significant differences between the restored monochrome image and the sampled monochrome image or the secured colour image (for example, less than a predefined number of pixel intensities diverge between the restored monochrome image and the sampled monochrome image), it is determined that the secured colour image is the original one and that no tampering was performed.

For example, the following well-known method in the art can be used for the estimation of a global threshold applied to the absolute difference between the restored monochrome image and the sampled monochrome image: Nobuyuki Otsu (1979). “A threshold selection method from gray-level histograms”. IEEE Trans. Sys. Man. Cyber. 9 (1): 62-66. The divergences between the sampled monochrome image and the secured colour image can be marked visually (for example highlighted) and displayed on a screen for a user to see at first glance.

According to an embodiment of the third aspect, the secured colour image for which the tampering detection is performed in the tampering detection method of the third aspect is obtained by the method of the first aspect or any embodiment thereof.

According to a further embodiment of the third aspect, the colour model is an RGB (red-green-blue) color model having a red component, a green component and a blue component as its colour components, wherein the color component information indicates that the encoding has been performed in the red and blue components only, and wherein the decoding algorithm calculates, for a selected pixel pair,
DR=IR1−IR2, wherein DR designates the calculated difference for the red component, IR1 designates an intensity of the red component of a first selected pixel of the selected pixel pair and IR2 designates an intensity of the red component of a second selected pixel of the selected pixel pair; and
DB=IB2−IB1, wherein DB designates the calculated difference for the blue component, IB1 designates an intensity of the blue component of the first selected pixel of the selected pixel pair and IB2 designates an intensity of the blue component of the second selected pixel of the selected pixel pair.

In the case where the red and blue components of the encodable image were used to encode the reduced monochrome image in a complementary and opposite manner (in order to compensate for the sensitivity of the human visual system, as described in view of the first aspect), the corresponding decoding is also done in a complementary and opposite manner. Namely, the order of subtraction of the pixels of a single pixel pair is reversed for the red component as compared to the order in the blue component.

In particular, the method may include decoding only one of the colour components (preferably the blue colour component) as the different colour components encode redundant information. If a discrepancy or problem is noted (detection) in one pixel block (localization) in the decoded colour component, the decoding of the other colour component(s) can be used to confirm or invalidate the discrepancy or problem, and in some cases to correct the discrepancy or problem (correction). Such a discrepancy or problem can also be noted if the increments δ for the different colour components do not satisfy the expected ratio (for example of δR=δB/3).

According to a further embodiment of the third aspect, the secured colour image has embedded an error-correction code and/or an error-detection code, said code being calculated from an intensity of at least one pixel of the reduced monochrome image, and/or the secured colour image has embedded descriptive information regarding an object or a person represented on the digital colour image, the method further comprising:
accessing a predefined verification pattern defining locations of pixel pairs in the secured colour image encoding the error-correction code, the error-detection code and/or the descriptive information;
decoding the error-correction code, the error-detection code and/or the descriptive information embedded in the secured colour image using the decoding algorithm applied to each pixel pair of the secured colour image defined in the predefined verification pattern, wherein the decoding algorithm calculates, for each pixel pair of the at least one colour component encoding the error-correction code, the error-detection code and/or the descriptive information, a value of a difference between intensities of the pixel pair.

The error-correction code, an error-detection code and/or the descriptive information is as defined above in view of the method of the first aspect. The decoding thereof can be done along the same lines as the decoding of the pixel pairs encoding the reduced monochrome image into the encodable image, namely using the decoding algorithm.

The decoding algorithm bases the decoding of the error-correction code, the error-detection code and/or the descriptive information upon the predefined verification pattern which defines which pixels pairs of the secured colour image comprise which information amongst the error-correction code, the error-detection code and/or the descriptive information. The predefined verification pattern can be part of the predefined specific pattern.

Decoding the error-correction code and/or the error-detection code allows determining that some of the pixels of the received or captured secured colour image are not as expected, thereby prompting a user to recapture the secured colour image, for example, or correcting these discrepancies in case of the error-correction code. If the errors persist, this can also be indicative of tampering.

In particular, if the error-correction code does not allow correcting the intensity values of the corresponding pixel block, this can be indicative of a problem in said pixel block. This may render a user (such as security agent) particularly alert of said pixel block.

According to a further embodiment of the third aspect, the predefined specific pattern indicates which pixel pairs of the secured colour image encode which pixel of the reduced monochrome image, wherein the step of restoring the reduced monochrome image embedded in the secured colour image comprises:
based on the sign of the calculated difference of each pixel pair encoding one encoded pixel of the reduced monochrome image, determining whether each pixel pair encoding the encoded pixel encodes a “0”-bit or a “1”-bit;
assembling the decoded bits corresponding to the encoded pixel according to the predefined specific pattern to obtain a binary number indicative of an intensity of the encoded pixel of the reduced monochrome image.

From the sign of the difference between pixel intensities calculated for a pixel pair, the value (bit) encoded by said pixel pair can be determined. By determining all bits encoded by all pixel pairs and assembling them in accordance with the specific pattern, the bits associated with each encoded pixel of the reduced monochrome image are obtained. In other words, the intensities of each pixel of the reduced monochrome image can be obtained. This allows reconstructing (restoring) the reduced monochrome image embedded (encoded) in the secured colour image.

The order of the steps of any of the methods defined herein can be modified.

According to a further aspect, a generation module (hardware and software) for generating a secured colour image is provided. The generation module comprises a processor for performing all method steps of the method of the first aspect or any embodiment thereof.

According to a further aspect, a tampering detection module (hardware and software) for detecting tampering on a secured colour image is provided. The tampering detection module comprises a processor for performing all method steps of the method of the third aspect or any embodiment thereof.

The present invention will be described more fully hereinafter with reference to the accompanying drawings in which like numerals represent like elements throughout the different figures, and in which prominent aspects and features of the invention are illustrated.

### BRIEF DESCRIPTION OF THE DRAWINGS

FIG. 1 shows a method of generating a secured colour image;

FIG. 2 illustrates an embedding of a pixel of a reduced monochrome image into a pixel block of an encodable image;

FIG. 3 illustrates an embedding of a pixel of a reduced monochrome image into different colour components of an encodable image;

FIG. 4 shows an example of a pixel block including an error-correction code, an error-detection code and/or descriptive information;

FIG. 5 shows an example of a predefined specific pattern;

FIG. 6 shows a method of detecting tampering of a secured colour image; and

FIG. 7 shows an encoding of information in a two-dimensional pattern as known from U.S. Pat. No. 9,141,899 B2.

### DETAILED DESCRIPTION

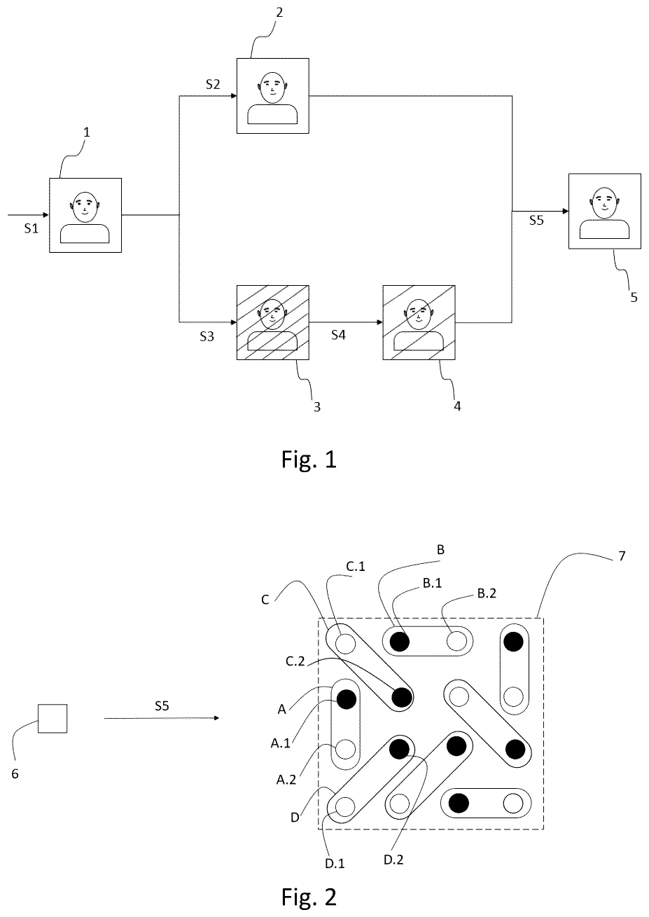

FIG. 1 shows a method for generating a secured colour image 5 according to an embodiment of the invention. The method of FIG. 1 allows embedding a greyscale (monochrome) representation of a coloured image into said coloured image to prevent tampering attacks against the coloured image. The method is entirely computer-implemented. The method of FIG. 1 includes method steps S1 to S5.

In the embodiments described based on the enclosed figures, all images are portrait photographs of a human. The secured colour image 5 to be created using the method of FIG. 1 is meant to be used as an identification photograph on a passport (which is an example for an identity document).

Step S1 of the method of FIG. 1 forms a step of receiving or capturing a digital colour image 1. In the example of FIG. 1, in step S1, a printed photograph of a bald man (who is the legitimate holder of the passport) is scanned (corresponding to a “capturing”) using a flatbed scanner. As a result, a digital colour image 1 is obtained, which is a digitalized version of the scanned-in photograph.

In a step S2 of the method of FIG. 1, an encodable image 2 is generated from the digital colour image 1. To render the digital colour image 1 encodable, it is checked that its dynamic range is sufficiently small to encode additional information therein, in particular by performing a desired level of intensity modulation δ. To this end, step S2 includes the calculation of the dynamic range of the digital colour image 1, namely finding the maximum pixel intensity and the minimum pixel intensity of the image 1. Here, it is determined that the digital colour image 1 has intensities comprised between 0 and 99 on a possible scale of 0 to 100, and hence a dynamic range of 99. As intensity values of the image 1 of 0 to 5 and of 95 to 99 do not allow an intensity modulation of δ=5 (value provided as a mere example, preferably, δ is between 3% and 7% of the maximum possible dynamic range), the dynamic range of the digital image is reduced by multiplying all the pixel intensities of the image 1 by a reduction factor f=0.9, thereby obtaining pixel intensities between 0 and 90. Then, the resulting pixel intensities are shifted by a shifting factor, which is here chosen as being equal to δ (but can alternatively be selected as being different from δ), thereby obtaining intensities between 5 and 95, which all allow encoding the increment δ. The resulting image with a reduced dynamic range and shifted intensities forms an encodable image 2.

If the calculation of the dynamic range had instead indicated that the modulation of δ=5 was always possible, no reduction of the image 1 would have been necessary and the digital colour image 1 would have been set as the encodable image 2.

In a step S3 of the method of FIG. 1, the digital colour image 1 is converted into a monochrome image 3. The monochrome image 3 is here a greyscale image. In FIG. 1, the greyscale image 3 is represented with stripes on it for distinguishing it from the coloured images 1, 2.

In a step S4 of the method of FIG. 1, a resolution of the greyscale image 3 is reduced to obtain a monochrome (greyscale) image 4 (reduced monochrome image 4) with a reduced resolution (represented with a reduced stripe density in FIG. 1). The resolution reduction of step S4 includes reducing the total number of pixels in the greyscale image 3.

In a step S5 of the method of FIG. 1, the secured colour image 5 is generated. To this end, the greyscale image 4 is embedded into the encodable image 2 using an embedding algorithm. The resulting colour image 5 looks identical to the digital colour image 1 to a human, but it includes the greyscale image 4 therein. The embedding of the greyscale image 4 into the encodable image 2 is described in more detail with reference to FIG. 2, which will be described jointly with FIG. 1 in the following.

Namely, the greyscale image 4 is made of multiple pixels 6. The embedding algorithm encodes each of these pixels 6 in several pixel pairs (differential pairs) DPA-DPD of the encodable image 2. In detail, each pixel 6 of the greyscale image 4 has a given grey tone that is defined through its intensity. This intensity is expressed as a binary number of four bits. In the example of FIG. 2, the pixel 6 to be encoded has an intensity of “12”, which is expressed as “1100” in binary.

The encodable image 2 includes one pixel block 7 for encoding each one pixel 6 of the greyscale image 4. An example of such a pixel block 7 is shown in FIG. 2. One such pixel block 7 consists of sixteen pixels 8 arranged in a 4×4 matrix. The sixteen pixels 8 of the pixel block 7 form eight pixel pairs A-D (see FIG. 4). Each pixel pair A-D allows encoding one bit. Each pixel pair A-D includes two pixels labeled as n.1 and n.2, for n corresponding to the letters A to D.

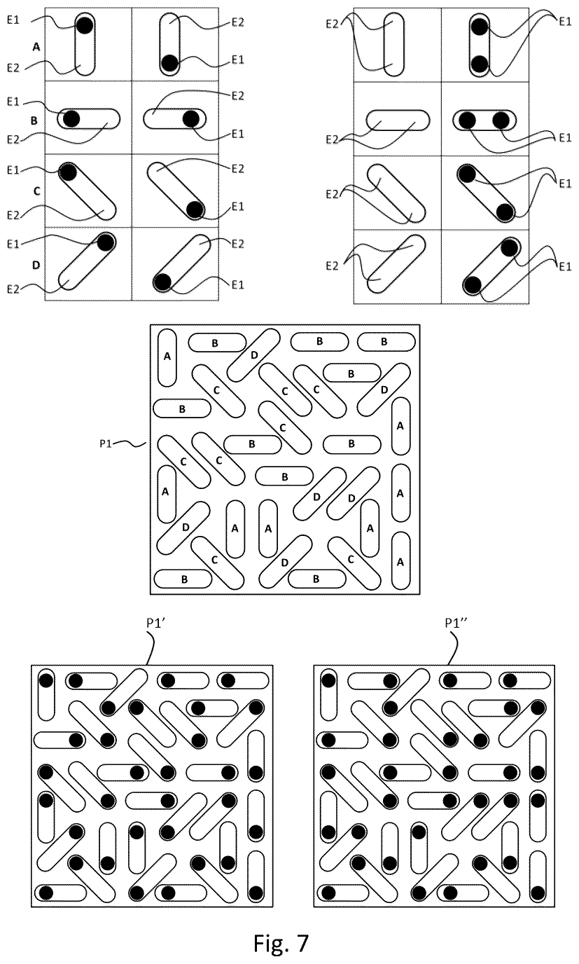

The encoding of one bit of information by each pixel pair A-D is based on the principle disclosed in the U.S. Pat. No. 9,141,899 B2, which is described with reference to FIG. 7. As defined therein, a two-dimensional code is created using pixel pairs A-D. Each pixel can have to different states E1 and E2 (black and white dots for simplicity). A pixel pair can thus have four different states corresponding to all possible ways of combining the two possible states of the two pixels forming the pixel pair (namely E1-E2, E2-E1, E1-E1 and E2-E2). Out of these four states, only the states in which the two pixels of the pixel pair have opposite states are valid (that is, E1-E2 and E2-E1 are valid, while E1-E1 and E2-E2 are invalid). In the US patent, the pixel pair A-D have the following allowable states: A1, A2, B1, B2, C1, C2, D1 and D2. In the mentioned US patent, the pixel pairs A-D are arranged according to a predetermined pattern P1 offering the possibility of encoding multiple valid two-dimensional codes P1′ and P1″.

Now based on the principle described in the above-mentioned US patent and referring again to FIGS. 1-3, each pixel pair A-D encodes one bit of information relating to the pixel 6 of the greyscale image 4. In the example of FIG. 2, in which the pixel 6 is represented by the binary number ABCD=1100, the pixel pair A encodes the value A=1 (forming a pixel pair A1), the pixel pair B encodes the value B=1 (forming a pixel pair B1), the pixel pair C encodes the value C=0 (forming a pixel pair C2) and the pixel pair D encodes the value D=0 (forming a pixel pair D2). Instead of encoding the bits by setting the pixels as black and white points as it is done in the US patent, in the encoding of step S5 of FIG. 1, an increment δ is used to modulate the encodable image 2 and accordingly represent the bit to be encoded.

Namely, in each pixel pair A-D, the embedding algorithm sets an intensity of a first pixel A.1, B.1, C.2, D.2 as a sum of a mean intensity I of the pixel pair A-D and the increment δ (corresponding to a black pixel in FIG. 2), and sets an intensity of a second pixel A.2, B.2, C.1, D.1 as a difference of the mean intensity I of the pixel pair A-D minus the increment δ (corresponding to a white pixel in FIG. 2).

In other words, for the pixel pair A, in order to encode a “1” (which is the state shown in FIG. 2), the pixels A.1 and A.2 are encoded as follows:

$$IA \text{.1} T = I + δ , and$$

$$IA \text{.2} T = I - δ ,$$

wherein IA.1T is the intensity of the transformed pixel A.1, IA.2T is the intensity of the transformed pixel A.2, I is the mean intensity of the pixel pair A (namely I=(IA.1+IA.2)/2, with IA.1 and IA.2 respectively being the intensities of the pixels A.1 and A.2 before being transformed), and the increment δ having a value of 5 in the present example.

The same transformation applies to the remaining pixel pairs B-D in order to encode the remaining bits representing the pixel 6 of the greyscale image.

Namely, for the pixel pair B, in order to encode a “1” (which is the state shown in FIG. 2), the pixels B.1 and B.2 are encoded as follows:

$$IB \text{.1} = I + δ , and$$

$$IB \text{.2} T = I - δ ,$$

wherein IB.1T is the intensity of the transformed pixel B.1, IB.2T is the intensity of the transformed pixel B.2, I is the mean intensity of the pixel pair B (namely I=(IB.1+IB.2)/2, with IB.1 and IB.2 respectively being the intensities of the pixels B.1 and B.2 before being transformed), and the increment δ having a value of 5 in the present example.

For the pixel pair C, in order to encode a “0” (which is the state shown in FIG. 2), the pixels C.1 and C.2 are encoded as follows:

$$IC \text{.2} T = I + δ , and$$

$$IC \text{.1} T = I - δ ,$$

wherein IC.1T is the intensity of the transformed pixel C.1, IC.2T is the intensity of the transformed pixel C.2, I is the mean intensity of the pixel pair C (namely I=(IC.1+IC.2)/2, with IC.1 and IC.2 respectively being the intensities of the pixels C.1 and C.2 before being transformed), and the increment δ having a value of 5 in the present example.

Finally, for the pixel pair D, in order to encode a “0” (which is the state shown in FIG. 2), the pixels D.1 and D.2 are encoded as follows:

$$ID \text{.2} T = I + δ , and$$

$$ID \text{.1} T = I - δ ,$$

wherein ID.1T is the intensity of the transformed pixel D.1, ID.2T is the intensity of the transformed pixel D.2, I is the mean intensity of the pixel pair D (namely I=(ID.1+ID.2)/2, with ID.1 and ID.2 respectively being the intensities of the pixels D.1 and D.2 before being transformed), and the increment δ having a value of 5 in the present example.

Overall, in each pixel pair A-D, the intensity modifications performed by adding or subtracting the increment δ add up to zero so that the intensity modification is barely or not at all visible by a human eye. Thus, by the above method of FIGS. 1 and 2, the greyscale image 4 is hidden inside the encodable image 2, thereby providing a secured colour image 5 that allows recognizing tampering attacks.

In the embodiment of FIGS. 1 and 2, the embedding algorithm modifies all colour components of the encodable image 2 in the same manner to encode the greyscale image 4 therein. Alternatively, the embedding algorithm modifies only one colour component of the encodable image 2 to encode the greyscale image 4 therein.

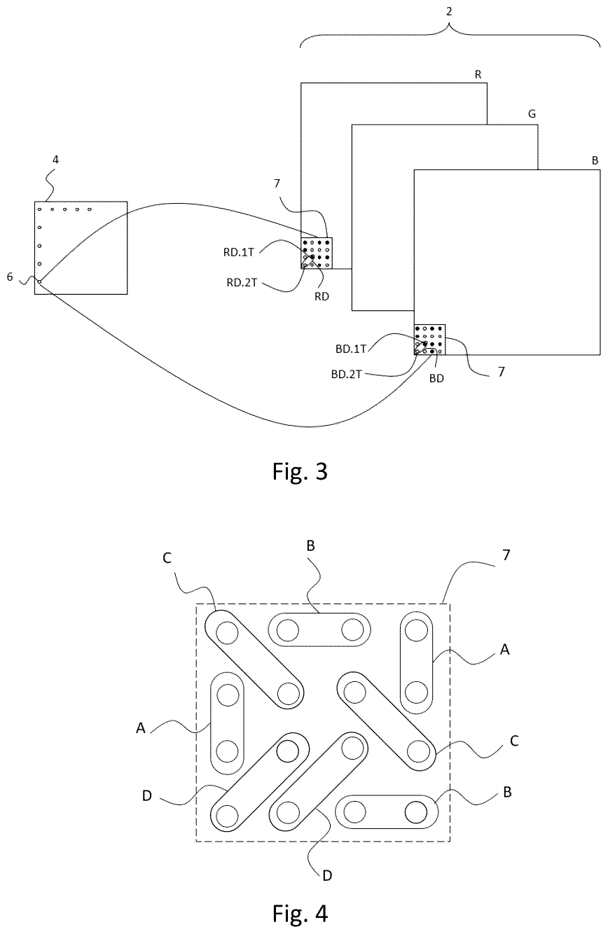

Yet another alternative is shown in FIG. 3, in which only a red component R and a blue component B of the RGB colour model of the encodable image 2 are modified to encode the greyscale image 4. Namely, as shown in FIG. 3, the pixel 6 of the greyscale image 2 is doubly encoded, namely in the red component R and in the blue component B of the encodable image 2. The reason for selecting the red and blue components R, B to hide the greyscale image 4 (payload) is that the human visual system is less sensitive to red and blue than to green, allowing to hide the greyscale image 4 in a less visible manner. To allow an even less visible hiding, the operations performed on the pixel pairs A-D of the red colour component R are the opposite to the ones performed on the pixel pairs A-D of the blue colour component B.

In the example of FIG. 3, the pixels RD.1 and RD.2 of the red component R are encoded as follows:

$$IRD \text{.1} T = I + δ R , and$$

$$IRD \text{.2} T = I - δ R ,$$

wherein IRD.1T is the intensity of the transformed pixel RD.1, IRD.2T is the intensity of the transformed pixel RD.2, I is the mean intensity of the pixel pair RD (namely I=(IRD.1+IRD.2)/2, with IRD.1 and IRD.2 respectively being the intensities of the pixels RD.1 and RD.2 before being transformed), and δR is the increment δ for the red component R.

In the example of FIG. 3, the pixels BD.1 and BD.2 of the blue component are encoded as follows:

$$IBD \text{.1} T = I - δ B , and$$

$$IBD \text{.2} T = I + δ B ,$$

wherein IBD.1T is the intensity of the transformed pixel BD.1, IBD.2T is the intensity of the transformed pixel BD.2, I is the mean intensity of the pixel pair BD (namely I=(IBD.1+IBD.2)/2, with IBD.1 and IBD.2 respectively being the intensities of the pixels BD.1 and BD.2 before being transformed), and δB is the increment δ for the blue component B.

Further, in the embodiment of FIG. 3, δB=5 and δR=δB/3, accounting even further for the differences in sensitivity to the different colours of the human visual system and allowing to hide the payload in an invisible manner.

As shown in FIG. 4, each pixel block 7 includes not only the pixel pairs A-D shown in FIG. 2 for encoding the greyscale image but also additional pixel pairs A-D for encoding an error-correction code and descriptive information. The error-correction code and the descriptive information are encoded as binary numbers, with one bit being encoded by one pixel pair A-D. The encoding of the error-correction code and the descriptive information is thus identical to the encoding of the pixel 6 into the pixel block 7. The error-correction code is a Reed-Solomon code allowing to detect and correct an error in the read pixel intensities. The descriptive information includes a name and date of birth of the holder of the identity document represented on the secured colour image 5, and hence allows verifying that these indications have not been altered in the identity document.

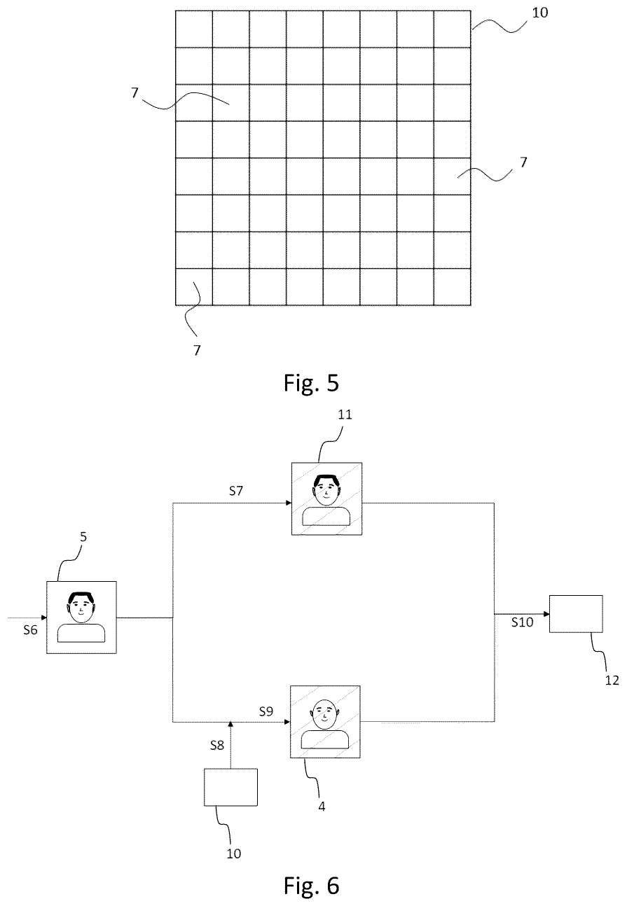

An indication regarding which pixel 6 of the greyscale image 4 is to be encoded in which pixel pairs of the encodable image 2 is provided in a predefined specific pattern 10, an example of which is shown in FIG. 5. In the example of FIG. 5, the specific pattern 10 includes a matrix of 8×8 identical pixel blocks 7. The specific pattern 10 is a map used by the encoding algorithm to uniquely assign each pixel 6 of the greyscale image to the pixel pairs encoding it.

Once the secured colour image 5 has been generated in accordance with the method of FIG. 1 and/or in accordance with one of the aspects described in view of FIGS. 2 to 5, it is printed on the identity document. Any unallowable modification (tampering) of the image 5 will be detectable by decoding the image 5 to retrieve the greyscale image 4 hidden therein and comparing it with a greyscale version of the image 5 being tested for tampering.

The method for tampering detection will be described in the following with regards to FIG. 6. Said tampering detection method is performed in a fully autonomous manner using a computerized tampering detection module. The method of detecting tampering of FIG. 6 includes steps S6 to S10. In a step S6, the secured colour image 5 (as described above) is received (in a digital format) or captured (using a scanner). As can be seen in FIG. 6, the secured colour image 5 has been modified: some hair and larger ears have been added to the bald human from the original image 5 shown in FIG. 1.

In an optional step S7 of FIG. 6, the secured colour image 5 is converted into a sampled monochrome image 11 with a reduced resolution, which is here a greyscale image. The greyscale image 11 being obtained directly from the visible part of the secured colour image 5, it is representative of what is visible to the human. Hence, the greyscale image 11 obtained in step S7 of FIG. 6 shows a human with hair and larger ears.

In a step S8 of FIG. 6, the tampering detection module accesses the predefined specific pattern 10 stored thereon and indicating which pixel pairs DP of the secured colour image 5 encode which information from the greyscale image 4 hidden therein. Further, the tampering detection module accesses colour component information stored thereon indicating which colour components of the secured colour image 5 encode the greyscale image 4.

In a step S9 of FIG. 6, the secured colour image 5 is decoded. This is done under consideration of the specific pattern 10 and the colour component information received in step S8. The decoding is done according to a decoding algorithm which calculates, for each pixel pair A-D of the specific pattern 10, a difference between the intensities of the two pixels DP1 and DP2 for each colour component indicated by the colour component information. A sign of the difference between the intensities of the two pixels DP1 and DP2 indicates whether the corresponding pixel pair encodes a “0” or a “1”. Using the correspondences from the specific pattern 10, the binary number corresponding to each pixel 6 of the encoded greyscale image 4 (and hence its intensity) is determined. This allows restoring the greyscale image 4 encoded in the secured colour image 5.

In a step S10, a comparison between the restored greyscale image 4 and the sampled greyscale image 11 (with the reduced resolution) is performed. The following well-known method in the art is used for the estimation of a threshold applied to the absolute difference between the restored greyscale image 4 and the sampled greyscale image 11: Nobuyuki Otsu (1979). “A threshold selection method from gray-level histograms”. IEEE Trans. Sys. Man. Cyber. 9 (1): 62-66. The comparison includes determining a percentage of pixels for which the intensity of the restored greyscale image 4 does not match that of the samples greyscale image 11. For a percentage above 3% (value provided as an example), a tampering is determined. For a percentage below 3%, no tampering is determined. A tampering detection result 12 is output by the tampering detection module, allowing determining tampering in an automatic and reliable manner.

The above disclosed subject matter is to be considered illustrative, and not restrictive, and serves to provide a better understanding of the invention defined by the independent claims. For example, other methods for obtaining an encodable image 2 are feasible. The dimension, shape and number of pixels in a pixel block can vary. The values for the increment δ and/or for the dynamic range can be modified. The tampering detection method may further include steps such as decoding and/or verifying error-correction and/or error-detection codes encoded in pixel pairs of the secured colour image.

### REFERENCE NUMERALS

1 digital colour image
2 encodable image
3 monochrome image
4 reduced monochrome image
5 secured colour image
6 pixel of monochrome image
7 pixel block
8 pixel of pixel block
10 predefined specific pattern
11 sampled monochrome image
12 tampering detection result
A-D pixel pair
R,G,B colour component
δ increment
δB increment of blue component
δR increment of red component

1. A method of generating a secured colour image, the method comprising:
receiving or capturing a digital colour image;
generating an encodable image from the digital colour image;
converting the digital colour image into a monochrome image;
reducing a resolution of the monochrome image to obtain a reduced monochrome image; and
generating the secured colour image by embedding the reduced monochrome image into the encodable image using an embedding algorithm modifying at least one colour component (R,G,B) of a colour model associated with the encodable image; wherein
the embedding algorithm allows encoding one pixel of the reduced monochrome image into at least part of a pixel block of the encodable image, the pixel block including multiple pixels which form pixel pairs; and
for each pixel pair, the embedding algorithm sets an intensity of a first pixel of the pixel pair in the at least one colour component as a sum of a mean intensity I of the pixel pair in the at least one colour component and an increment δ, and the embedding algorithm sets an intensity of a second pixel of the pixel pair in the at least one colour component as the mean intensity I of the pixel pair in the at least one colour component minus the same increment δ.

2. The method according to claim 1, wherein the colour model is an RGB color model having a red component (R), a green component (G) and a blue component (B) as its colour components, wherein the embedding algorithm modifies only the red component (R) and the blue component (B) of the encodable image.

3. The method according to claim 2, wherein the embedding algorithm modifies the red component (R) and the blue component (B) of the encodable image such that for a selected pixel pair, the embedding algorithm sets:
an intensity IR1 of the red component (R) of a first selected pixel of the selected pixel pair as IR1=IR+δR, wherein IR designates the mean intensity I of the selected pixel pair in the red component (R) and δR designates the increment δ for the red component (R);
an intensity IR2 of the red component (R) of a second selected pixel of the selected pixel pair as IR2=IR−δR;
an intensity IB1 of the blue component (B) of the first selected pixel of the selected pixel pair as IB1=IB−δB, wherein IB designates the mean intensity I of the selected pixel pair in the blue component (B) and δB designates the increment δ for the blue component (B); and
an intensity IB2 of the blue component (B) of the second selected pixel of the selected pixel pair as IB2=IB+δB.

4. The method according to claim 1, wherein the pixel pairs, in particular including the selected pixel pair, are arranged in a predefined specific pattern in the pixel block (7).

5. The method according to claim 1, wherein a value of the increment δ depends upon the modified colour component (R,G,B), in particular wherein
an increment δB for the blue component (B) is larger than an increment δR for the red component (R), in particular wherein δR<δB/2, more particularly wherein δR=δB/3.

6. The method of claim 1, wherein the step of generating an encodable image from the digital colour image comprises:
calculating a dynamic range of the digital colour image;
determining whether the calculated dynamic range allows for variations of plus and minus the increment δ;
if the calculated dynamic range does not allow for variations of plus and minus the increment δ, reducing the dynamic range of the digital colour image to obtain the encodable image;
if the calculated dynamic range allow for variations of plus and minus the increment δ, setting the digital colour image as the encodable image.

7. The method according to claim 1, wherein the pixel block includes 16 pixels arranged in a 4×4 matrix.

8. The method according to claim 1, wherein the embedding algorithm encodes the one pixel of the reduced monochrome image into at least part of the pixel block of the encodable image by:
associating a binary number of N bits to a colour intensity of the one pixel of the reduced monochrome image; and
embedding each of the N bits associated with the colour intensity into one of N pixel pairs of the pixel block of the encodable image.

9. The method according to claim 1, wherein the embedding algorithm additionally encodes
an error-correction code and/or an error-detection code calculated from an intensity of at least one pixel of the reduced monochrome image; and/or
descriptive information regarding an object or a person represented on the digital colour image;
wherein the error-correction code, the error-detection code and/or the descriptive information is at least partly stored into at least another pixel pair of the pixel block and/or of the encodable image; wherein in particular the error-correction code includes a Reed-Solomon code and/or the error-detection code includes a cyclic redundancy check code.

10. A secured colour image obtained by the method of claim 1 and having embedded a corresponding encoded reduced monochrome image.

11. A method of detecting tampering of a secured colour image, the method of detecting tampering comprising:
receiving or capturing a secured colour image to be tested for tampering, the secured colour image having embedded a corresponding encoded reduced monochrome image;
optionally converting the secured colour image into a sampled monochrome image;
accessing a predefined specific pattern defining locations of pixel pairs encoding the reduced monochrome image in the secured colour image, and accessing at least one colour component information indicating a color component in which an encoding has been performed in the secured colour image, the colour component (R,G,B) belonging to a colour model associated with the secured colour image;
decoding the secured colour image using a decoding algorithm applied to each pixel pair of the secured colour image defined in the predefined specific pattern, wherein the decoding algorithm calculates, for each pixel pair of the at least one colour component (R,G,B), a difference between intensities of the two pixels of the pixel pair;
restoring the reduced monochrome image embedded in the secured colour image based on a sign of the calculated difference for each pixel pair;
determining whether the secured colour image has been tampered upon comparing the restored reduced monochrome image embedded in the secured colour image with the sampled monochrome image and/or with the secured colour image, and accordingly evaluating whether the restored reduced monochrome image embedded in the secured colour image is visually similar with the sampled monochrome image and/or with the secured colour image.

12. The tampering detection method of claim 11, wherein the secured colour image for which the tampering detection is performed is obtained by the method of claim 1.

13. The tampering detection method of claim 11, wherein the colour model is an RGB color model having a red component (R), a green component (G) and a blue component (B) as its colour components (R,G,B), wherein the color component information indicates that the encoding has been performed in the red and blue components (R,B) only, and wherein the decoding algorithm calculates, for a selected pixel pair,
DR=IR1−IR2, wherein DR designates the calculated difference for the red component (R), IR1 designates an intensity of the red component (R) of a first selected pixel of the selected pixel pair and IR2 designates an intensity of the red component (R) of a second selected pixel of the selected pixel pair; and
DB=IB2−IB1, wherein DB designates the calculated difference for the blue component (B), IB1 designates an intensity of the blue component (B) of the first selected pixel of the selected pixel pair and IB2 designates an intensity of the blue component (B) of the second selected pixel of the selected pixel pair.

14. The tampering detection method according to claim 11, wherein the secured colour image has embedded an error-correction code and/or an error-detection code, said code being calculated from an intensity of at least one pixel of the reduced monochrome image, and/or the secured colour image has embedded descriptive information regarding an object or a person represented on the digital colour image, the method further comprising:
accessing a predefined verification pattern defining locations of pixel pairs in the secured colour image encoding the error-correction code, the error-detection code and/or the descriptive information;
decoding the error-correction code, the error-detection code and/or the descriptive information embedded in the secured colour image using the decoding algorithm applied to each pixel pair of the secured colour image defined in the predefined verification pattern, wherein the decoding algorithm calculates, for each pixel pair of the at least one colour component (R,G,B) encoding the error-correction code, the error-detection code and/or the descriptive information, a value of a difference between intensities of the pixel pair.

15. The tampering detection method according to claim 11, wherein the predefined specific pattern indicates which pixel pairs of the secured colour image encode which pixel of the reduced monochrome image, wherein the step of restoring the reduced monochrome image embedded in the secured colour image comprises:
based on the sign of the calculated difference of each pixel pair encoding one encoded pixel of the reduced monochrome image, determining whether each pixel pair encoding the encoded pixel encodes a “0”-bit or a “1”-bit;
assembling the decoded bits corresponding to the encoded pixel according to the predefined specific pattern to obtain a binary number indicative of an intensity of the encoded pixel of the reduced monochrome image.
